(19) United States
(12) Patent Application Publication
(10) Pub. No.: US 2017/0027788 A1
(43) Pub. Date: Feb. 2, 2017

(54) Mattress and Removable Bedpan Drawer Device

(71) Applicants: Carl F. Henderson, Lathrop, CA (US); Ida Henderson, Pittsburgh, PA (US); Carlos Henderson, Renton, WA (US)

(72) Inventors: Carl F. Henderson, Lathrop, CA (US); Ida Henderson, Pittsburgh, PA (US); Carlos Henderson, Renton, WA (US)

(21) Appl. No.: 15/150,654

(22) Filed: May 10, 2016

Related U.S. Application Data
(60) Provisional application No. 62/198,400, filed on Jul. 29, 2015.

(51) Int. Cl. A61G 7/02; A47C 21/00

(52) U.S. Cl. CPC A61G 7/02; A47C 21/00

(57) ABSTRACT

A modified mattress with a removable bedpan drawer. The modified mattress allows a person to rest thereon like a conventional bed. The device includes a bedpan drawer and a channel, wherein the channel extends along the width of the mattress. The channel is shaped to receive the bedpan drawer therethrough. The bedpan drawer is preferably rectangular in shape, and includes an upper side and a lower side. The upper side includes a recess configured to receive a bedpan therein. The device further includes a padded member removably covering the channel in order to allow a user to lie comfortably on the mattress. The padded member includes an opening aligned with the recess on the upper side of the drawer when the drawer is fully inserted into the channel, allowing the user to have access to the bedpan therebeneath.

### CROSS REFERENCE TO RELATED APPLICATION

This application claims the benefit of U.S. Provisional Application No. 62/198,400 filed on Jul. 29, 2015. The above identified patent application is herein incorporated by reference in its entirety to provide continuity of disclosure.

### BACKGROUND OF THE INVENTION

The present invention relates to modified mattresses. More specifically, the present invention provides a modified mattress with a removable bedpan drawer.

Patients in hospitals or in home care are often immobile and unable to walk to a bathroom without assistance. If assistance is unavailable, the individual may have no choice but to relieve themselves while in bed, causing the individual to lie in their own excrement until assistance arrives. In addition to an unsanitary environment for the patient, more work is created for the person providing assistance to the patient, such as cleaning and replacing the soiled bedding.

Alternatively, a patient may have a bedpan nearby in order to relieve themselves while lying in bed. However, situating a bedpan beneath a patient and above the mattress is challenging and uncomfortable for the patient. Further, the patient must be lifted off the mattress in order to place the bedpan therebeneath, which can be difficult for a caretaker. Therefore, there exists a need for a device that will allow a patient with limited mobility to relieve themselves while lying down without assistance from a caretaker.

Devices have been disclosed in the prior art that relate to modified mattresses. These include devices that have been patented and published in patent application publications. These devices generally relate to mattresses having an opening and a bedpan disposed beneath the opening for receiving waste therein. These prior art devices have several known drawbacks. These devices fail to provide a mattress having a channel that extends completely therethrough in order to allow a bedpan drawer to be removed from either side of the mattress. The present invention also includes a removable insert that covers a recess of the bedpan drawer that allows a patient to easily access the bedpan drawer therebeneath so as to prevent the need of assistance in order to go to the bathroom while lying down on a bed.

In light of the devices disclosed in the prior art, it is submitted that the present invention substantially diverges in design elements from the prior art and consequently it is clear that there is a need in the art for an improvement to existing modified mattress devices. In this regard the instant invention substantially fulfills these needs.

### SUMMARY OF THE INVENTION

In view of the foregoing disadvantages inherent in the known mattresses having removable bedpans now present in the prior art, the present invention provides a new mattress with a removable bedpan drawer device wherein the same can be utilized for providing convenience for the user when going to the bathroom while lying in bed without needing assistance of a caretaker.

It is therefore an object of the present invention to provide a new and improved mattress with a removable bedpan drawer device that has all of the advantages of the prior art and none of the disadvantages. The modified mattress is configured similarly to a conventional mattress, wherein the mattress includes a channel that extends along the width thereof along the upper surface of the mattress. The channel is shaped to removably receive a bedpan drawer therethrough, wherein the bedpan drawer is movable. The bedpan drawer is preferably rectangular in shape, wherein the bedpan drawer includes an upper side and a lower side. The upper side includes a recess configured to receive a bedpan therein. The present invention further includes a padded member that removably covers the channel and the drawer therein, wherein the padded member is disposed in the same plane as the upper surface of the mattress so as to form a continuous surface. The padded member includes an opening aligned with the recess on the upper side of the drawer when the drawer is fully inserted into the channel, allowing the user to have access to the bedpan therebeneath. An insert removably covers the opening of the padded member in order to allow a user to rest thereon.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the present invention.

FIG. 2 shows an exploded view of an embodiment of the present invention.

FIG. 3 shows a cross sectional view of an embodiment of the present invention.

### DETAILED DESCRIPTION OF THE INVENTION

Reference is made herein to the attached drawings. Like reference numerals are used throughout the drawings to depict like or similar elements of the mattress with a removable bedpan drawer device. For the purposes of presenting a brief and clear description of the present invention, the preferred embodiment will be discussed as used for providing convenience for the user when going to the bathroom while lying in bed without requiring the assistance of a caretaker. The figures are intended for representative purposes only and should not be considered to be limiting in any respect.

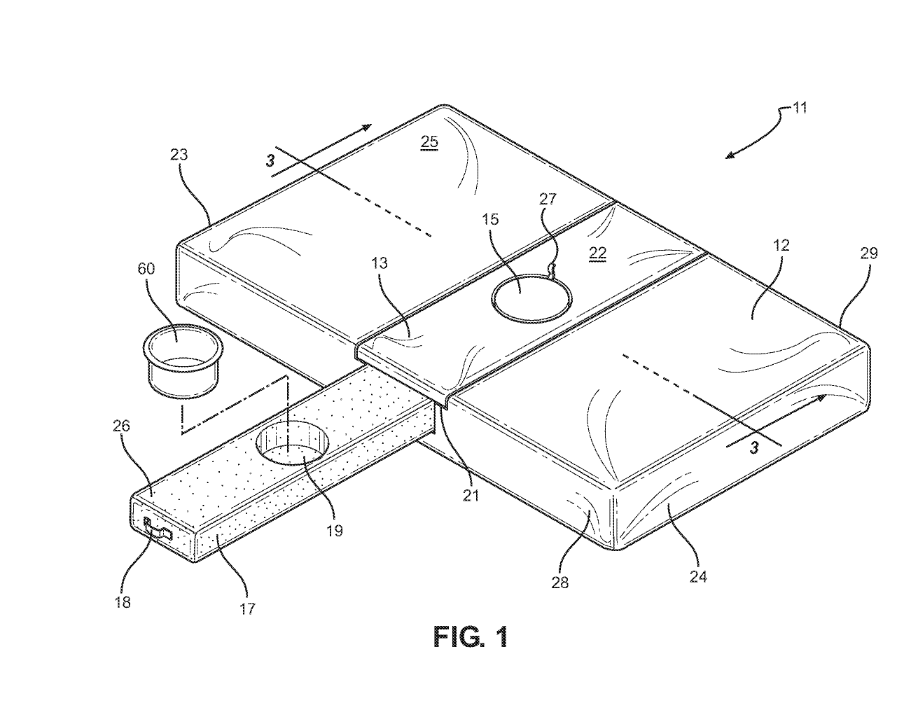

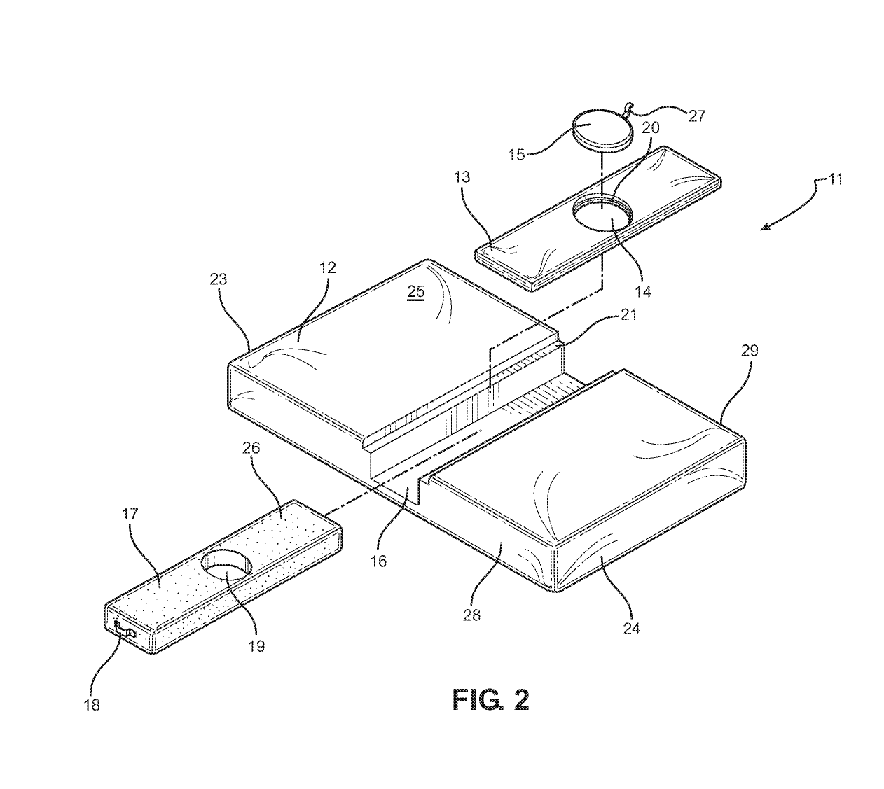

Referring now to FIGS. 1 and 2, there is shown a perspective view and an exploded view of an embodiment of the present invention. The present invention 11 comprises a mattress 12 configured to allow a person to rest thereon. In the illustrated embodiment, the mattress 12 is rectangular in shape and includes a flat upper surface 25. The mattress 12 comprises any suitable conventional mattress materials, such as a foam mattress, an innerspring mattress, a heavy duty mattress, among others. The mattress 12 is configured to be positioned on a bedframe, such as a planar box spring or an adjustable hospital bedframe, for use thereon. The mattress 12 includes a depth in order to provide cushioning or the desired comfort for a user lying thereon.

The mattress 12 comprises a channel 16 that extends along the width thereof, from a first lateral side 28 of the mattress 12 to a second lateral side 29 thereof. In the illustrated embodiment, the channel 16 comprises a rectangle cross section. Preferably, the channel 16 is disposed centrally between a first end 23 and a second end 24 of the mattress 12 so as to align beneath a user's genitals when lying thereon. The channel 16 comprises a pair of open ends and is configured to receive a bedpan drawer 17 therethrough. The open ends of the channel 16 allows a bedpan drawer 17 to be conveniently removed from either side of the mattress 12. The upper end of the channel 16 comprises a lip 21 disposed below the surface 25 of the mattress 12. The lip 21 is configured to receive a padded member 13 thereon.

The device 11 further comprises the padded member 13, wherein the padded member 13 removably covers the channel 16 and is configured to allow a portion of a user to rest thereon. In the illustrated embodiment, the padded member 13 comprises a rectangular shape, wherein the length thereof is substantially equivalent to the width of the mattress 12 and the length of the channel 16 in order to prevent the padded member 13 from extending beyond the lateral sides 28, 29 of the mattress 12. The lower surface of the padded member 13 rests flush on the lip 21 of the channel 16 and the upper surface 22 thereof is aligned flush with the upper surface 25 of the mattress 12. The padded member 13 allows an upper surface 25 of the mattress 12 to be flat and in a singular plane, wherein it is removable in order to fully access the channel 16 for cleaning purposes.

The padded member 13 includes an opening 14 centrally located thereon in order to provide access to a bedpan 60 positioned therebeneath. An insert 15 removably covers the opening 14 in order to allow the upper surface 25 of the mattress 12 to be flat and in a singular plane when the bedpan 60 does not need to be accessed by the user. In some embodiments, a second lip 20 extends outward from the lower end of the opening 14 of the padded member 13 and is configured to receive the removable insert 15 thereon. In this way, the insert 15 is supported on the padded member 13. In alternate embodiments, the removable insert 15 comprises a tab 27 or strap extending therefrom that allows a user to easily lift the insert off of the opening 14. In the illustrated embodiment the opening 14 and insert 15 comprise a circular cross section.

Preferably, the bedpan drawer 17 is rectangular in shape and includes an upper side 26 and a lower side. The bedpan drawer 17 is configured to fit within the channel 16, wherein the upper side 26 aligns flush with the lip extending outward from the upper end of the channel 16. In the illustrated embodiment, the bedpan drawer 17 extends the length of the channel 16. The bedpan drawer 17 is composed of any suitable durable material adapted to slide within the channel 16, such as hard plastic. In alternate embodiments, the channel 16 and bedpan drawer comprise a sliding mechanism, such as a track, in order to allow the bedpan drawer 17 to conveniently slide in and out of the channel. The bedpan drawer 17 further comprises a handle 18 disposed on each end thereof. The handles 18 allow the bedpan drawer 17 to be conveniently removed or placed within the channel.

The upper side 26 of the bedpan drawer 17 includes a recess 19 configured to receive a bedpan 60 therein. In the illustrated embodiment, the recess 19 comprises a circular cross section, however, in alternate embodiments, the recess can comprise any suitable shape in order to receive a bedpan 60 therein. The recess 19 is centrally located on the bedpan drawer 17 and aligns below the opening 14 in the padded member 13 when the drawer is fully inserted into the channel in order to allow the bedpan 60 to receive human waste, such as feces and urine, therein.

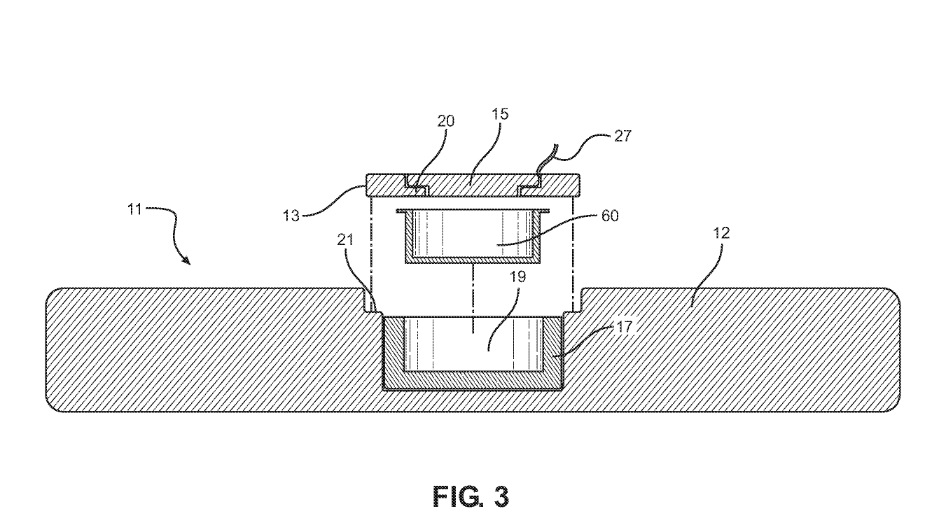

Referring now to FIG. 3, there is shown a cross sectional view of an embodiment of the present invention. In operation, a bedpan 60 is placed within the recess 19 and the bedpan drawer 17 is positioned within the channel. The padded member 13 is positioned on the lip 21 of the channel so as to allow the upper end of the padded member 13 to align flush with the upper surface of the mattress 12. The removable insert 15 is positioned over the opening of the padded member 13, resting on the second lip 20 extending therefrom. A user lies on the upper surface of the mattress 12. If the user needs to go to the bathroom while remaining on the mattress 12, he or she removes the insert 15 from the padded member 13 by pulling the tab 27 or strap thereon so that he or she has access to the bedpan 60 located therebeneath. When the user has completed going to the bathroom, he or she replaces the removable insert 15. The bedpan 60 can be used repeatedly until without the immediate need of assistance in order to lift the user to use a conventional bedpan 60 typically placed on top of a conventional mattress.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A mattress and removable bedpan drawer device comprising:
a mattress having a first lateral side opposing a second lateral side, wherein a channel extends from the first lateral side to the second lateral side;
a bedpan drawer removably disposed within the channel, wherein the bedpan drawer comprises a recess on an upper side thereof and is configured to receive a bedpan within the recess;
a padded member removably covering the channel, wherein the padded member comprises an opening configured to receive waste therethrough.

2) The mattress and removable bedpan drawer device of claim 1, wherein the channel comprises a lip extending inward from an upper end thereof and configured to receive the padded member thereon.

3) The mattress and removable bedpan drawer device of claim 1, wherein the bedpan drawer comprises a first handle disposed on a first side thereof and a second handle disposed on a second side thereof.

4) The mattress and removable bedpan drawer device of claim 1, wherein an upper side of the padded member is aligned flush with an upper surface of the mattress when removably covering the channel.

5) The mattress and removable bedpan drawer device of claim 1, further comprising an insert removably covering the opening of the padded member.

6) The mattress and removable bedpan drawer device of claim 1, further comprising a bedpan disposed in the recess.

7) A mattress and removable bedpan drawer device comprising:
a mattress having a first lateral side opposing a second lateral side, wherein a channel extends from the first lateral side to the second lateral side;
a bedpan drawer removably disposed within the channel, wherein the bedpan drawer comprises a recess disposed on an upper side thereof and is configured to receive a bedpan within the recess;
a padded member removably covering the channel and comprising an opening configured to receive waste therethrough;
wherein an upper side of the padded member is aligned flush with an upper surface of the mattress;
a lip extending inward from an upper end of the channel and configured to receive the padded member thereon;
an insert removably covering the opening of the padded member.
